(19) United States
(12) Patent Application Publication
(10) Pub. No.: US 2025/0245385 A1
(43) Pub. Date: Jul. 31, 2025

(54) ANONYMIZED HUMAN LIVENESS DETECTION FOR AN INFORMATION HANDLING SYSTEM

(71) Applicant: Dell Products L.P., Round Rock, TX (US)

(72) Inventors: Maxwell S. Andrews, Kennett Square, PA (US); Charles D. Robison, Buford, GA (US)

(73) Assignee: Dell Products L.P., Round Rock, TX (US)

(21) Appl. No.: 18/424,090

(22) Filed: Jan. 26, 2024

(51) Int. Cl. G06F 21/62; G06F 21/31

(52) U.S. Cl. CPC G06F 21/629; G06F 21/316; G06F 2221/2141

(57) ABSTRACT

An information handling system may receive, from a first sensor of the information handling system, first sensor data. The information handling system may receive, from a second sensor of the information handling system, second sensor data. Based, at least in part, on the first sensor data and the second sensor data, the information handling system may generate a plurality of security profiles for the information handling system. Based, at least in part, on the first sensor data and the second sensor data, the information handling system may apply a security profile of the plurality of security profiles to the information handling system.

### FIELD OF THE DISCLOSURE

The present disclosure generally relates to information handling systems, and more particularly relates to regulating access to users based on a behavior score.

### BACKGROUND

As the value and use of information increases, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

Users today interact with many cloud services, including social media, commerce services, etc. Often such cloud services find it useful to verify the uniqueness and liveness of users in order to reduce instances of fraud and manipulation, and also to accurately report monetizable users for the purpose of financial forecasting and resource allocation. Requiring users to submit conventional identity documents for verification is onerous, and creates its own set of risks around handling and storing this private information.

Shortcomings mentioned here are only representative and are included simply to highlight that a need exists for improved information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

### I. General Disclosures

This disclosure describes a method and system of confirming the uniqueness and quality of a user through a unique impression of prior activity across numerous platforms, culminating in a public user behavioral score, with more costly activities resulting in higher standing of legitimacy. In some embodiments, a user may be assigned an immutable digital user identifier. In some embodiments, the immutable digital user identifier may be associated with a behavioral score calculated via compounding positive and negative anonymous behavior tracking and scoring across numerous platforms. For example, in some embodiments, users with longer histories of human-like positive activity may gain privileges and status across participating application systems, whereas users with short histories or negative behavior scores may be given reduced privileges and access to limit the impact of their destructive or inauthentic behavior. In some embodiments, identifying genuine and positively engaged users can be provided as decentralized infrastructure, creating efficiencies across participating applications.

### II. Methods of the Disclosure

The present disclosure is directed to a method of confirming the uniqueness and quality of a user through a unique impression of prior activity across numerous platforms, culminating in a public user behavioral score, with more costly activities resulting in higher standing of legitimacy. In some embodiments, a second information handling system with a platform software system, may facilitate communication between a first information handling system managed by an end user, and a public third information handling system maintaining a behavioral score. In some embodiments, the second information handling system may receive from a first information handling system, a decentralized identifier associated with multiple platform software systems for an end user.

In some embodiments, the second information handling system may request from a third information handling system, a behavior score. In some embodiments, the behavior score reflects a pattern of behavior derived from a plurality of interactions of the user with members of the ecosystem. In some embodiments, the behavior score is a weighted calculation of at least two of the following: a positive social engagement, a transaction history, a third party verification, or an activity pattern score, etc.

In some embodiments, the second information handling system may control access to one or more application services provided by the second information handling system based on the behavior score. In some embodiments, the second information handling system may associate, a set of permissions for the one or more application services, available on the second information handling system, to the decentralized identifier.

In some embodiments, the second information handling system may compare a first behavior score threshold value with the behavior score provided by the third information handling system. In some embodiments, if the behavior score provided is greater than a first behavior threshold value then access to an initial set of application services, available on the second information handling system, is associated to the decentralized identifier of the user. In some embodiments, if the behavior score provided is greater than a subsequent threshold value, then access to an subsequent set of application services, available on the second information handling system, is associated to the decentralized identifier of the user.

In some embodiments, the second entity may send to the third entity an access use record associated with the decentralized identifier. In some embodiments, the access use record comprises at least one of a record of a positive social engagement, a transaction history, a third party verification, or an activity patterns scores. In some embodiments, the access use record is encrypted with a private key associated with the second entity. In some embodiments, the private key encrypted access use record provided by the second entity to the third entity may be used to adjust the public behavior score.

The platform software system may provide services such as educational learning, online shopping, community posting, etc. The first, second, and/or third information handling system may, for example, include a personal computer, tablet, smartphone, gaming console, or other information handling system operated by the user to execute one or more applications. Alternatively or additionally, the first, second, and/or third information handling system may include a server, such as a server of a cloud service, acting as an intermediary between an information handling system operated by a user, service application, and/or behavior score creator to execute one or more applications on an information handling system.

### III. Systems of the Disclosure

The present disclosure is directed to a system for confirming the uniqueness and quality of a user through a unique impression of prior activity across numerous platforms, culminating in a public user behavioral score. In some embodiments, a second information handling system with a platform software system, may facilitate communication between a first information handling system managed by an end user, and a public third information handling system maintaining a behavioral score. In some embodiments, the second information handling system may receive from a first information handling system, a decentralized identifier associated with multiple platform software systems for an end user.

In some embodiments, the second information handling system may request from a third information handling system, a behavior score. In some embodiments, the behavior score reflects a pattern of behavior derived from a plurality of interactions of the user with members of the ecosystem. In some embodiments, the behavior score is a weighted calculation of at least two of the following: a positive social engagement, a transaction history, a third party verification, or an activity pattern score, etc.

In some embodiments, the second information handling system may control access to one or more application services provided by the second information handling system based on the behavior score. In some embodiments, the second information handling system may associate, a set of permissions for the one or more application services, available on the second information handling system, to the decentralized identifier.

In some embodiments, the second information handling system may compare a first behavior score threshold value with the behavior score provided by the third information handling system. In some embodiments, if the behavior score provided is greater than a first behavior threshold value then access to an initial set of application services, available on the second information handling system, is associated to the decentralized identifier of the user. In some embodiments, if the behavior score provided is greater than a subsequent threshold value, then access to an subsequent set of application services, available on the second information handling system, is associated to the decentralized identifier of the user.

In some embodiments, the second entity may send to the third entity an access use record associated with the decentralized identifier. In some embodiments, the access use record comprises at least one of a record of a positive social engagement, a transaction history, a third party verification, or an activity patterns scores. In some embodiments, the access use record is encrypted with a private key associated with the second entity. In some embodiments, the private key encrypted access use record provided by the second entity to the third entity may be used to adjust the public behavior score.

An information handling system may include a memory, a first sensor, a second sensor, and a processor for performing the steps described herein. Alternatively or additionally, a computer program product may include a non-transitory computer-readable medium comprising instructions to cause a controller to perform the steps described herein.

The foregoing has outlined rather broadly certain features and technical advantages of embodiments of the present invention in order that the detailed description that follows may be better understood. Additional features and advantages may be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a diagram of an example of a first, second, and third information handling system according to some embodiments of the disclosure.

FIG. 2 is a block diagram of one embodiment of an anonymized human liveness detection according to some embodiments of the disclosure.

FIG. 3 is a block diagram of an example method for creating the behavior score according to some embodiments of the disclosure.

FIG. 4 is a block diagram of one embodiment of an anonymized human liveness detection according to some embodiments of the disclosure.

FIGS. 5A and 5B are block diagrams of one embodiment for updating the public behavior score according to some embodiments of the disclosure.

FIG. 6 is a schematic block diagram of an example information handling system according to some embodiments of the disclosure.

### DETAILED DESCRIPTION OF THE DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications and with several different types of architectures.

### I. Example Description of Terms

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

In describing the some embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the some embodiments.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

Throughout this specification, unless the context requires otherwise, the words “comprise”, “comprises” and “comprising” will be understood to imply the inclusion of a stated step or element or group of steps or elements but not the exclusion of any other step or element or group of steps or elements. Further, the words “comprising” (and any form of comprising, such as “comprise” and “comprises”), “having” (and any form of having, such as “have” and “has”), “including” (and any form of including, such as “includes” and “include”), “characterized by” (and any form of including, such as “characterized as”), or “containing” (and any form of containing, such as “contains” and “contain”) are inclusive or open-ended and do not exclude additional, unrecited elements or method steps. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present embodiment. Thus, the appearances of the foregoing phrases in various places throughout this specification are not necessarily all referring to the same embodiment. Furthermore, the particular features, structures, or characteristics may be combined in any suitable manner in some embodiments.

### II. General Embodiments

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more virtual or physical buses operable to transmit communications between the various hardware and/or software components.

### III. Methods of the Disclosure

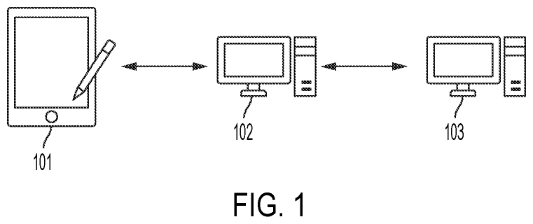

A method for managing information handling system user access may include using information collected from a variety of information handling systems. In some embodiments, FIG. 1 demonstrates how at least three information handling systems may communicate. In some embodiments, a first information handling system 101 is operated by a user. In some embodiments, the first information handling system 101 may communicate with a second information handling system 102 via terrestrial or wireless means. In some embodiments, the first information handling system 101 may send a decentralized identifier associated with multiple software platform systems. In some embodiments, the second information handling system 102 may contain application services the user has requested access to. In some embodiments, the second information handling system 102 may communicate with a third information handling system 103 via terrestrial or wireless means. In some embodiments, the second information handling system 102 may control the access that the first information handling system 101 has to the application services present on the second information handling system 102. In some embodiments, the third information handling system 103 may be where the public behavior scores are stored in a database or registry. In some embodiments, the second information handling system 102 may send data to the third information handling system 103 to update the stored behavior score.

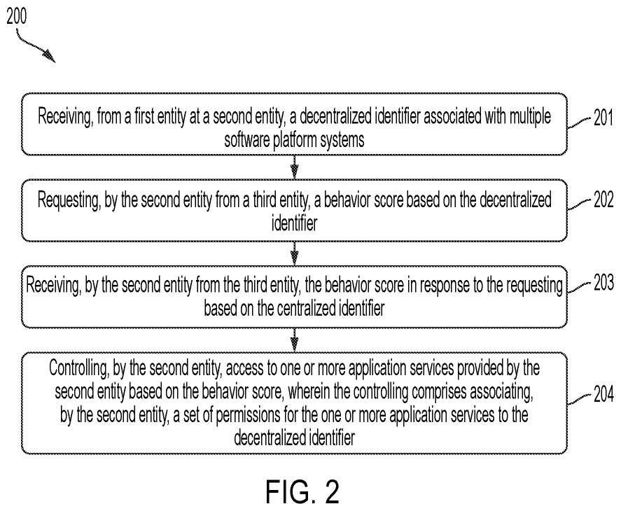

FIG. 2 is a flowchart illustrating an example method 200 for anonymized human liveness detection for an information handling system. Aspects of the method 200 can be executed by the first, second, and third information handling systems (101, 102, and 103 of FIG. 1) and/or other suitable means for performing the steps. As illustrated, the method 200 includes a number of enumerated steps, but aspects of the method 200 may include additional steps before, after, and in between the enumerated steps. In some embodiments, one or more of the enumerated steps may be omitted or performed in a different order.

At block 201, in some embodiments, the method 200 includes a second entity 102 of FIG. 1 receiving a decentralized identifier associated with multiple software platform systems from a first entity 101 of FIG. 1. In some embodiments, the decentralized identifier may comprise a unique and anonymous name for the user. In some embodiments, the name may be associated with the user for one, some, or all of the applications on the first entity 101 of FIG. 1. In some embodiments, the first entity 101 of FIG. 1 may be a user device, such as but not limited to, a tablet, a smart phone, a computer, etc. In some embodiments, one non-limiting example may include a user opening a social media application on their tablet 101 of FIG. 1. In some embodiments, the tablet 101 of FIG. 1 may message an identifier of the user to the server 102 of FIG. 1 of the social media application the user opened. In some embodiments, one non-limiting example may include a user accessing a game application on their computer 101 of FIG. 1. In some embodiments, the computer 101 of FIG. 1 may then message an identifier of the user to the server 102 of FIG. 1 of the computer game the user opened.

At block 202, in some embodiments, the method 200 includes a second entity 102 of FIG. 1 requesting a behavior score associated with the decentralized identifier from a third entity 103 of FIG. 1. In some embodiments, the third entity 103 of FIG. 1 may be a public server maintained by a third party, such as but not limited to, a social media association, a trade association, an internet association, etc. In some embodiments, one non-limiting example of the behavior score may be a score between 0 and 100, inclusive. In some embodiments, the behavior score may be associated with the decentralized identifier. In some embodiments, the behavior score may be stored on the public server 103 of FIG. 1 that may be accessed by various parties comprising social media applications, computer games, shopping websites, etc.

At block 203, in some embodiments, the method 200 includes the second entity 102 of FIG. 1 receiving the behavior score from the third entity 103 of FIG. 1.

At block 204, in some embodiments, the method 200 includes the second entity 102 of FIG. 1 controlling access to one or more application services provided by the second entity 102 of FIG. 1 based on the behavior score. In some embodiments, the controlling comprises the second entity 102 of FIG. 1 associating a set of permissions for the one or more application services on the second entity 102 of FIG. 1 to the decentralized identifier. In some embodiments, a non-limiting example includes providing the decentralized identifier various levels of access to one or more of the applications of the second entity based on if the value of the behavior score associated with the decentralized identifier exceeds corresponding threshold amounts. In some embodiments, a non-limiting example includes providing the decentralized identifier limited partial access if the decentralized identifier associated behavior score is less than or equal to 25, more robust partial access if the decentralized identifier associated behavior score is greater than 25 but less than or equal to 75, while providing full access if the decentralized identifier associated behavior score is greater than 75.

In some embodiments, one or more aspects of method 200 may be a part of program instructions executable by a processor. For example, in some embodiments, a computer program product may comprise a computer readable storage medium having program instructions embodied therewith. The program instructions may be executable by a processor to cause the processor to perform a method comprising: receiving, from a first entity at a second entity, a decentralized identifier associated with multiple software platform systems; requesting, by the second entity from a third entity, a behavior score based on the decentralized identifier; receiving, by the second entity from the third entity, the behavior score in response to the requesting based on the decentralized identifier; controlling, by the second entity, access to one or more application services provided by the second entity based on the behavior score, wherein the controlling comprises associating, by the second entity, a set of permissions for the one or more application services to the decentralized identifier.

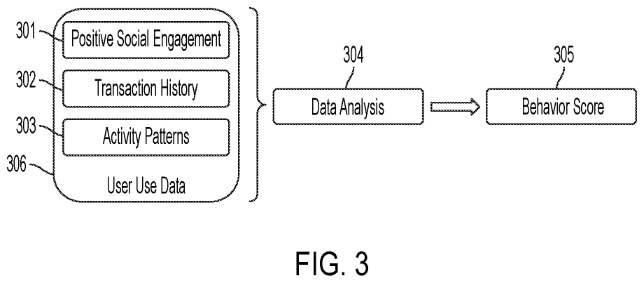

FIG. 3 shows an example workflow of creation and behavior score 305 according to some embodiments. In some embodiments, user use data 306 comprises positive social engagement 301, transaction history 302, activity patterns 303, etc. In some embodiments, user use data may 306 be some or all of the data describing the manner and frequency the user accessed one or more applications on the first entity 101 of FIG. 1. In some embodiments, at least three non-limiting examples of social engagement 301 may comprise the manner and frequency the user messages other users, post to message boards, and post reviews within the application. In some embodiments, at least three non-limiting examples of transaction history 302 may comprise the purchase amounts, purchase frequency, return amounts, etc. conducted by the user. In some embodiments, at least three non-limiting examples of user activity patterns 303 may comprise irregular mouse movement, irregular clicking of various links, time spent at various parts of the application, etc.

In some embodiments, such data is aggregated via data analysis 304. In some embodiments, one non-limiting example of aggregation of the data would take into account the positive social engagements 301, the transaction history 302, and the activity patterns 303 of the user of the one or more applications. In some embodiments, the data aggregation is done via a weighted calculation of at least two of the following: positive social engagement 301, transaction history 302, activity patterns 303, etc. In some embodiments, the output of data analysis 304 is the behavior score 305.

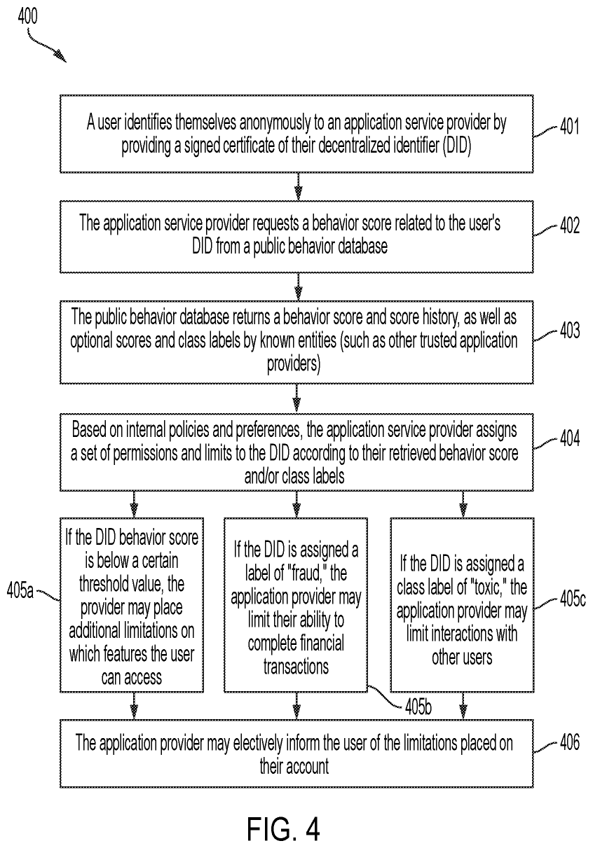

FIG. 4 is a flowchart illustrating an example method for anonymized human liveness detection for an information handling system. Aspects of the method 400 can be executed by the first, second, and third information handling systems (101, 102, and 103 of FIG. 1) and/or other suitable means for performing the steps. As illustrated, the method 400 includes a number of enumerated steps, but aspects of the method 400 may include additional steps before, after, and in between the enumerated steps. In some embodiments, one or more of the enumerated steps may be omitted or performed in a different order.

At block 401, in some embodiments, a user identifies themselves anonymously to an application service provider by providing a signed certificate of their decentralized identifier.

At block 402, in some embodiments, the application service provider requests a behavior score related to the user's decentralized identifier from a public behavior database.

At block 403, in some embodiments, the public behavior database returns a behavior score and score history, as well as optional scores and class labels by known entities (such as other trusted application providers).

At block 404, in some embodiments, based on internal policies and preferences, the application service provider assigns a set of permissions and limitations to the decentralized identifier according to their retrieved behavior score and/or class labels.

At block 405a, in some embodiments, if the decentralized identifier behavior score is below a certain threshold value, the provider may place additional limitations on which features the user can access.

At block 405b, in some embodiments, if the decentralized identifier is assigned a label of “fraud,” the application provider may limit their ability to complete financial transactions.

At block 405c, in some embodiments, if the decentralized identifier is assigned a class label of “toxic,” the application provider may limit interactions with other users.

At block 406, in some embodiments, the application provider may electively inform the user of the limitations placed on their account.

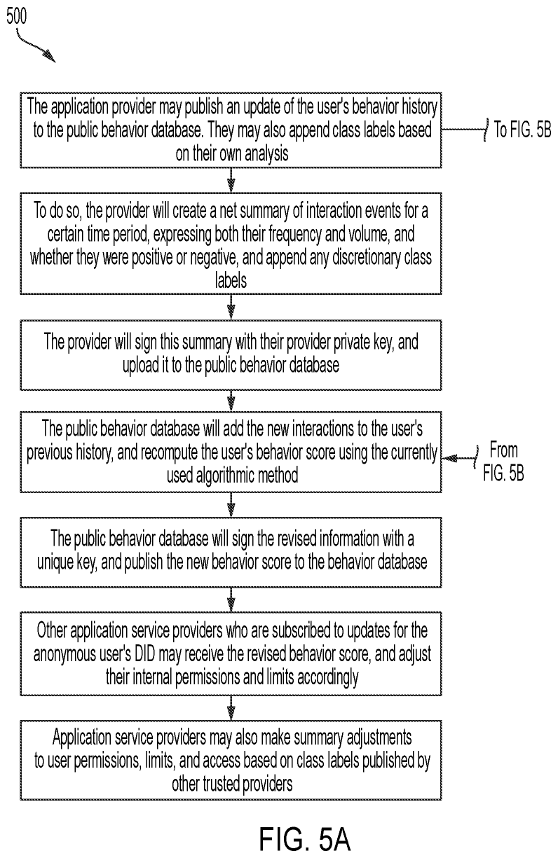

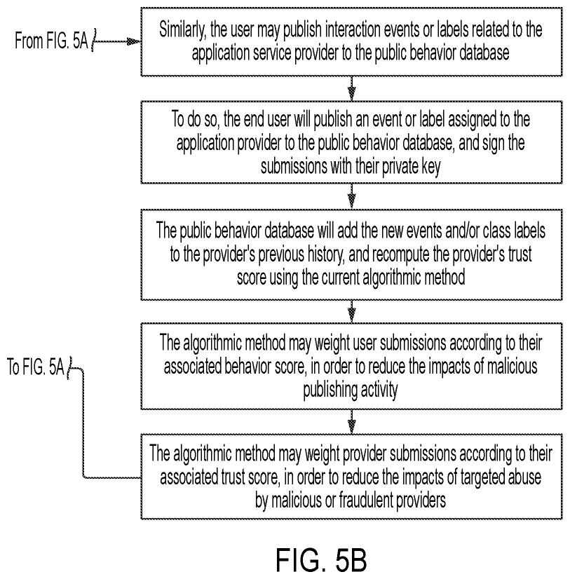

FIGS. 5A and 5B are flowcharts illustrating an example method for anonymized human liveness detection for an information handling system. Aspects of the method 500 can be executed by the first, second, and third information handling systems (101, 102, and 103 of FIG. 1) and/or other suitable means for performing the steps. As illustrated, the method 500 includes a number of enumerated steps, but aspects of the method 500 may include additional steps before, after, and in between the enumerated steps. In some embodiments, one or more of the enumerated steps may be omitted or performed in a different order.

In some embodiments, a non-limiting example may include multiple new user accounts that have recently been created on a digital social communication platform on an information handling system 101 of FIG. 1. The communication platform desires to confirm the uniqueness and legitimacy of the user accounts, since it would influence both the monetizable active user count and the degree to which actions of the user should be reflected in the social forum, including ranking and visibility of their content, and whether or not the sentiments they express are genuine and worthy of influencing content feeds for other users. In some embodiments, each user has an associated anonymized chain of transactions which is published to a public ledger on a public database 103 of FIG. 1 which can be independently audited. In some embodiments, certain nodes within the transaction history may be given higher weights based on their perceived cost, which would discourage simulated activity due to a high investment required. In some embodiments, in one non-limiting example a real person may have hundreds of confirmed financial transactions associated with their identity, which a “fake” account would be unlikely to reproduce because of the expense involved.

In some embodiments, a digital merchant service receives a transaction request on behalf of an anonymous user from a first information handling system 101 of FIG. 1. The merchant must verify that the user is trustworthy, or they may expose themselves to elevated risk of payment fraud, such as the user using a stolen credit card number or performing a payment chargeback after consuming services. Utilizing the method described in the disclosure, the merchant on the second information handling system 102 of FIG. 1 can query the behavior score of the user against their decentralized identifier in a publicly accessible ledger on the public database 103 of FIG. 1; thus, confirming the quality of the user without needing to collect or confirm any identifying information from the end user, preserving their anonymity.

In some embodiments, a digital polling system allows users to express their opinions or cast their vote for a specified purpose on a first information handling system 101 of FIG. 1. The publisher of the poll has an interest in the responses to the poll being unique and genuine, but cannot verify the uniqueness of respondents without verifying their identity, which is often impossible or impractical. In some embodiments, in one non-limiting example the poll publisher can independently verify the uniqueness and trustworthiness of each respondent, while preserving anonymity and a frictionless experience for respondents using the disclosed method.

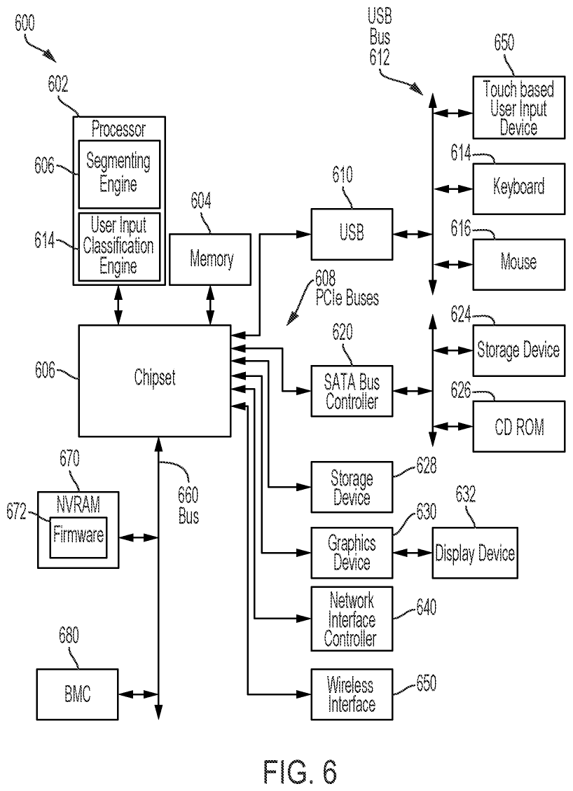

FIG. 6 illustrates an example information handling system 600. Information handling system 600 may include a processor 602 (e.g., a central processing unit (CPU)), a memory (e.g., a dynamic random-access memory (DRAM)) 604, and a chipset 606. In some embodiments, one or more of the processor 602, the memory 604, and the chipset 606 may be included on a motherboard (also referred to as a mainboard), which is a printed circuit board (PCB) with embedded conductors organized as transmission lines between the processor 602, the memory 604, the chipset 606, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 602, the memory 604, the chipset 606, and/or other components may be organized as a System on Chip (SoC).

The processor 602 may execute program code by accessing instructions loaded into memory 604 from a storage device, executing the instructions to operate on data also loaded into memory 604 from a storage device, and generate output data that is stored back into memory 604 or sent to another component. The processor 602 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 602 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 606 may facilitate the transfer of data between the processor 602, the memory 604, and other components. In some embodiments, chipset 606 may include two or more integrated circuits (ICs), such as a northbridge controller coupled to the processor 602, the memory 604, and a southbridge controller, with the southbridge controller coupled to the other components such as USB 610, SATA 620, and PCie buses 608. The chipset 606 may couple to other components through one or more PCie buses 608.

Some components may be coupled to one bus line of the PCie buses 608, whereas some components may be coupled to more than one bus line of the PCie buses 608. One example component is a universal serial bus (USB) controller 610, which interfaces the chipset 606 to a USB bus 612. A USB bus 612 may couple input/output components such as a keyboard 614 and a mouse 616, but also other components such as USB flash drives, or another information handling system. Another example component is a SATA bus controller 620, which couples the chipset 606 to a SATA bus 622. The SATA bus 622 may facilitate efficient transfer of data between the chipset 606 and components coupled to the chipset 606 and a storage device 624 (e.g., a hard disk drive (HDD) or solid-state disk drive (SDD)) and/or a compact disc read-only memory (CD-ROM) 626. The PCie bus 608 may also couple the chipset 606 directly to a storage device 628 (e.g., a solid-state disk drive (SDD)). A further example of an example component is a graphics device 630 (e.g., a graphics processing unit (GPU)) for generating output to a display device 632, a network interface controller (NIC) 640, and/or a wireless interface 650 (e.g., a wireless local area network (WLAN) or wireless wide area network (WW AN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces). In some embodiments, chipset 606 may be directly connected to an individual end point via a PCie root port within the chipset and a point-to-point topology as shown in FIG. 6.

The chipset 606 may also be coupled to a serial peripheral interface (SPI) and/or Inter-Integrated Circuit (I2C) bus 660, which couples the chipset 606 to system management components. For example, a non-volatile random-access memory (NVRAM) 670 for storing firmware 672 may be coupled to the bus 660. As another example, a controller, such as a baseboard management controller (BMC) 680, may be coupled to the chipset 606 through the bus 660. BMC 680 may be referred to as a service processor or embedded controller (EC). Capabilities and functions provided by BMC 680 may vary considerably based on the type of information handling system. For example, the term baseboard management system may be used to describe an embedded processor included at a server, while an embedded controller may be found in a consumer-level device. As disclosed herein, BMC 680 represents a processing device different from processor 602, which provides various management functions for information handling system 600. For example, an embedded controller may be responsible for power management, cooling management, and the like. An embedded controller included at a data storage system may be referred to as a storage enclosure processor or a chassis processor.

System 600 may include additional processors that are configured to provide localized or specific control functions, such as a battery management controller. Bus 660 can include one or more busses, including a Serial Peripheral Interface (SPI) bus, an Inter-Integrated Circuit (I2C) bus, a system management bus (SMBUS), a power management bus (PMBUS), or the like. BMC 680 may be configured to provide out-of-band access to devices at information handling system 600. Out-of-band access in the context of the bus 660 may refer to operations performed prior to execution of firmware 672 by processor 602 to initialize operation of system 600.

Firmware 672 may include instructions executable by processor 602 to initialize and test the hardware components of system 600. For example, the instructions may cause the processor 602 to execute a power-on self-test (POST). The instructions may further cause the processor 602 to load a boot loader or an operating system (OS) from a mass storage device. Firmware 672 additionally may provide an abstraction layer for the hardware, such as a consistent way for application programs and operating systems to interact with the keyboard, display, and other input/output devices. When power is first applied to information handling system 600, the system may begin a sequence of initialization procedures, such as a boot procedure or a secure boot procedure. During the initialization sequence, also referred to as a boot sequence, components of system 600 may be configured and enabled for operation and device drivers may be installed. Device drivers may provide an interface through which other components of the system 600 can communicate with a corresponding device. The firmware 672 may include a basic input-output system (BIOS) and/or include a unified extensible firmware interface (UEFI). Firmware 672 may also include one or more firmware modules of the information handling system. Additionally, configuration settings for the firmware 672 and firmware of the information handling system 600 may be stored in the NVRAM 670. NVRAM 670 may, for example, be a non-volatile firmware memory of the information handling system 600 and may store a firmware memory map namespace 600 of the information handling system. NVRAM 670 may further store one or more container-specific firmware memory map namespaces for one or more containers concurrently executed by the information handling system.

Information handling system 600 may include additional components and additional busses, not shown for clarity. For example, system 600 may include multiple processor cores (either within processor 602 or separately coupled to the chipset 606 or through the PCie buses 608), audio devices (such as may be coupled to the chipset 606 through one of the PCie busses 608), or the like. While a particular arrangement of bus technologies and interconnections is illustrated for the purpose of example, one of skill will appreciate that the techniques disclosed herein are applicable to other system architectures. System 600 may include multiple processors and/or redundant bus controllers. In some embodiments, one or more components may be integrated together in an integrated circuit (IC), which is circuitry built on a common substrate. For example, portions of chipset 606 can be integrated within processor 602. Additional components of information handling system 600 may include one or more storage devices that may store machine-executable code, one or more communications ports for communicating with external devices, and various input and output (1/0) devices, such as a keyboard, a mouse, and a video display.

In some embodiments, processor 602 may include multiple processors, such as multiple processing cores for parallel processing by the information handling system 600. For example, the information handling system 600 may include a server comprising multiple processors for parallel processing. In some embodiments, the information handling system 600 may support virtual machine (VM) operation, with multiple virtualized instances of one or more operating systems executed in parallel by the information handling system 600. For example, resources, such as processors or processing cores of the information handling system may be assigned to multiple containerized instances of one or more operating systems of the information handling system 600 executed in parallel. A container may, for example, be a virtual machine executed by the information handling system 600 for execution of an instance of an operating system by the information handling system 600. Thus, for example, multiple users may remotely connect to the information handling system 600, such as in a cloud computing configuration, to utilize resources of the information handling system 600, such as memory, processors, and other hardware, firmware, and software capabilities of the information handling system 600. Parallel execution of multiple containers by the information handling system 600 may allow the information handling system 600 to execute tasks for multiple users in parallel secure virtual environments. For example, parallel execution of services described herein may occur in parallel virtualized containers.

The flow chart diagrams of FIGS. 2, 4, 5, and 6 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
receiving, from a first entity at a second entity, a decentralized identifier associated with multiple software platform systems;
requesting, by the second entity from a third entity, a behavior score based on the decentralized identifier;
receiving, by the second entity from the third entity, the behavior score in response to the requesting based on the decentralized identifier;
controlling, by the second entity, access to one or more application services provided by the second entity based on the behavior score, wherein the controlling comprises associating, by the second entity, a set of permissions for the one or more application services to the decentralized identifier.

2. The method of claim 1, wherein the behavior score reflects a pattern of behavior derived from a plurality of interactions of a user with other users of at least one of the multiple software platform systems.

3. The method of claim 1, wherein the behavior score comprises a weighted calculation of at least two of a positive social engagement, a transaction history, a third party verification, or an activity pattern score.

4. The method of claim 1, further comprising:
sending, by the second entity to the third entity, an access use record associated with the decentralized identifier,
wherein the access use record comprises at least one of a record of a positive social engagement, a transaction history, a third party verification, or an activity patterns scores.

5. The method of claim 4, wherein the access use record is encrypted with a private key associated with the second entity.

6. The method of claim 1, wherein the controlling comprises comparing a first behavior score threshold value with the behavior score to determine if access to the one or more application services by the user associated with the decentralized identifier is allowed.

7. The method of claim 6, wherein the controlling comprises comparing a second behavior score threshold value with the behavior score to determine if the user is permitted limited access to the one or more application services.

8. An information handling system, comprising:
a processor;
a memory;
a decentralized identifier associated with multiple software platform systems;
a behavior score based on the decentralized identifier,
wherein the processor is configured to perform steps comprising:
receiving, from a first entity at a second entity, a decentralized identifier associated with multiple software platform systems;
requesting, by the second entity from a third entity, a behavior score based on the decentralized identifier;
receiving, by the second entity from the third entity, the behavior score in response to the requesting based on the decentralized identifier;
controlling, by the second entity, access to one or more application services provided by the second entity based on the behavior score, wherein the controlling comprises associating, by the second entity, a set of permissions for the one or more application services to the decentralized identifier.

9. The information handling system of claim 8, wherein the behavior score reflects a pattern of behavior derived from a plurality of interactions of a user with other users of at least one of the multiple software platform systems.

10. The information handling system of claim 8, wherein the behavior score comprises a weighted calculation of at least two of a positive social engagement, a transaction history, a third party verification, or an activity pattern score.

11. The information handling system of claim 8, further comprising:
sending, by the second entity to the third entity, an access use record associated with the decentralized identifier,
wherein the access use record comprises at least one of a record of a positive social engagement, a transaction history, a third party verification, or an activity patterns scores.

12. The information handling system of claim 11, wherein the access use record is encrypted with a private key associated with the second entity.

13. The information handling system of claim 8, wherein the controlling comprises comparing a first behavior score threshold value with the behavior score to determine if access to the one or more application services by the user associated with the decentralized identifier is allowed.

14. The information handling system of claim 13, wherein the controlling comprises comparing a second behavior score threshold value with the behavior score to determine if the user is permitted limited access to the one or more application services.

15. A computer program product comprising:
a non-transitory computer readable medium comprising instructions for causing an information handling system to perform steps comprising:
receiving, from a first entity at a second entity, a decentralized identifier associated with multiple software platform systems;
requesting, by the second entity from a third entity, a behavior score based on the decentralized identifier;
receiving, by the second entity from the third entity, the behavior score in response to the requesting based on the decentralized identifier;
controlling, by the second entity, access to one or more application services provided by the second entity based on the behavior score, wherein the controlling comprises associating, by the second entity, a set of permissions for the one or more application services to the decentralized identifier.

16. The computer program product of claim 15, wherein the behavior score reflects a pattern of behavior derived from a plurality of interactions of a user with other users of at least one of the multiple software platform systems.

17. The computer program product of claim 15, wherein the behavior score comprises a weighted calculation of at least two of a positive social engagement, a transaction history, a third party verification, or an activity pattern score.

18. The computer program product of claim 15, further comprising:
sending, by the second entity to the third entity, an access use record associated with the decentralized identifier,
wherein the access use record comprises at least one of a record of a positive social engagement, a transaction history, a third party verification, or an activity patterns scores.

19. The computer program product of claim 18, wherein the access use record is encrypted with a private key associated with the second entity.

20. The computer program product of claim 15, wherein the controlling comprises comparing a first behavior score threshold value with the behavior score to determine if access to the one or more application services by the user associated with the decentralized identifier is allowed, and wherein the controlling comprises comparing a second behavior score threshold value with the behavior score to determine if the user is permitted limited access to the one or more application services.
